(19) United States
(12) Patent Application Publication
(10) Pub. No.: US 2005/0211458 A1
(43) Pub. Date: Sep. 29, 2005

(54) Electronic device for cutting high frequency noise outputs

(75) Inventor: Toshio Sakamoto, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/071,139

(22) Filed: Mar. 3, 2005

(30) Foreign Application Priority Data
Oct. 30, 2003 (JP) 2003-370666

(51) Int. Cl. H02G 3/08; H01J 5/00

(52) U.S. Cl. 174/50

(57) ABSTRACT

The present invention aims to reduce the amount of radiation of high-frequency noise outside an electronic device through a front bezel in the electronic device such as an optical disk apparatus. In order to achieve this object, in an enclosure, there is provided a conductor which is placed between the electronic component that emits high-frequency noise traveling toward a front bezel and the front bezel and has a length not less than a half of the wavelength of the high-frequency noise and both ends thereof are electrically open. Alternatively, the conductor has a length not less than a quarter of the wavelength of the high-frequency noise and one end makes electrical connection to the enclosure and the other end is electrically open.

### BACKGROUND OF THE INVENTION

1. Field of the Invention

The present invention relates to a technology for shielding high-frequency noise occurring in an electronic device, within an enclosure of the electronic device.

2. Description of Related Art

As conventional technologies related to the present invention, there are descriptions in Japanese Published Unexamined Patent Application (JP-A hereinafter) No. 2002-329343, JP-A No. 8-316679, and JP-A No. 2000-59063, for example. JP-A No. 2002-329343 describes a technology for using a chip capacitor soldered directly to a holder case in a shield case instead of a feed through capacitor as an optical pickup of an optical disk apparatus in order to prevent unwanted emissions radiating from a high-frequency superposed circuit of a laser diode. JP-A No. 8-316679 describes a configuration for providing a zonal conductive structure that encloses the edge of an opening such as a hole made in a conductive enclosure of an electronic device and makes electrical contact with the conductive enclosure in order to prevent electromagnetic waves from radiating, leaking, or invading from the opening. Further, JP-A No. 2000-59063 describes a configuration for making an opening in a shield case and placing a conductor larger than the opening inside or outside the shield case to make electrical contact with the shield case for the sake of reducing leakage of radiated interference waves as well as dissipating heat.

Among the above conventional technologies, the technology described in JP-A No. 2002-329343 is a technology for preventing unwanted emissions radiating from the high-frequency superposed circuit of the laser diode in the optical pickup, but not a technology for preventing high-frequency noise occurring in an electronic device from radiating outside the device through a front bezel. The technology described in JP-A No. 8-316679 is for providing the zonal conductive structure that encloses the edge of the opening in the conductive enclosure of the electronic device; however, in the case of a large opening area at a front bezel side, there is a possibility that sufficient shielding effect for electromagnetic waves can not be obtained. Further, it is probable that the technology described in JP-A No. 2000-59063 is applicable in the case where the size of the opening is smaller than that of the shield case but is not applicable to a large opening size such as an enclosure opening at a front bezel side of an electronic device.

### SUMMARY OF THE INVENTION

In view of the circumstances of the above conventional technologies, it is an object of the present invention to prevent, within an enclosure of an electronic device with a simple configuration, high-frequency noise occurring in the electronic device from radiating outside the device through a front bezel to provide the electronic device that emits a small amount of noise.

In order to achieve the above object, one preferred aspect of the present invention resides in an electronic device which comprises a reflecting unit for reflecting high-frequency noise in an enclosure made of conductive material, the reflecting unit being placed between an electronic component emitting the high-frequency noise and a front bezel placed at an opening of the enclosure. As the reflecting unit, there are provided, for example, a conductor which has a length not less than a half of the wavelength of the high-frequency noise and both ends thereof are electrically open and a conductor which has a length not less than a quarter of the wavelength of the high-frequency noise and one end makes electrical connection to the enclosure and the other end is electrically open.

Other and further objects, features and advantages of the invention will appear more fully from the following description.

### BRIEF DESCRIPTION OF THE DRAWINGS

FIG. 1 is a diagram showing a first embodiment of the present invention; and

FIG. 2 is a diagram showing a second embodiment of the present invention.

### DETAILED DESCRIPTION OF THE PREFERRED EMBODIMENTS

Referring to the drawings, the best modes for carrying out the present invention will be described below.

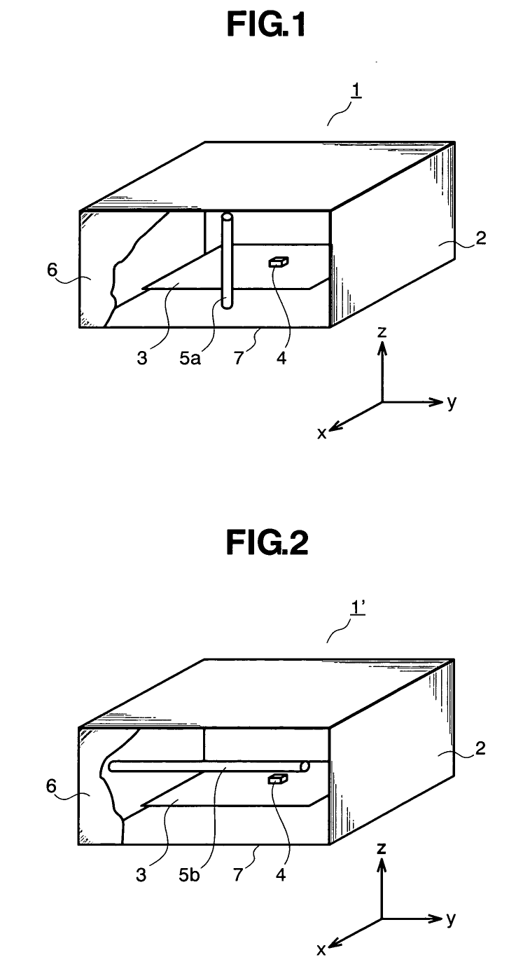

FIG. 1 and FIG. 2 are explanatory diagrams for embodiments of the present invention. FIG. 1 is a diagram of a configuration example of an electronic device according to a first embodiment of the present invention. FIG. 2 is a diagram of a configuration example of an electronic device according to a second embodiment of the present invention.

FIG. 1 of the first embodiment is the configuration example in the case where a vertically-polarized wave component (polarized wave component in the xz-plane) among high-frequency noise radiated from the inside of the electronic device is shielded within the device.

FIG. 1 illustrates an electronic device 1 according to the first embodiment of the present invention, an enclosure 2 of the electronic device 1 which is made of conductive plate material (conductive material), a circuit board 3, a high-frequency noise source 4 which emits high-frequency noise (electromagnetic waves) on the circuit board 3, a rod-like conductor 5a which is a noise reflecting unit reflecting the high-frequency noise radiated from the high-frequency noise source 4, a front bezel 6 which is placed at a front side of the electronic device 1, and an opening 7 of the enclosure 2 which is made at the front bezel 6 side. The conductor 5a is placed at an appropriate position between the high-frequency noise source 4 and the front bezel 6 in the enclosure 2 in a state where the conductor 5a has a length not less than a half of the wavelength of the high-frequency noise and both ends thereof are electrically open or in a state where the conductor 5a has a length not less than a quarter of the wavelength of the high-frequency noise and one end makes electrical connection to the enclosure 2 directly or indirectly and the other end is electrically open. The number of conductors 5a is one or more. If a frequency of the high-frequency noise is 2×10⁹ Hz for example, the length of the conductor 5a is made not less than approx. 7.5×10⁻² m in the case where both ends of the conductor 5a are electrically open and the length is not less than a half of the wavelength of the high-frequency noise, or the length is made not less than approx. 3.75×10⁻² m in the case where one end of the conductor 5a makes electrical connection to the enclosure 2 directly or indirectly and the length is not less than a quarter of the wavelength of the high-frequency noise. The front bezel 6 is provided with control buttons (not shown) etc. for controlling the electronic device 1 and is placed such that it closes the opening 7. In the case where the electronic device 1 is an optical disk apparatus for example, a high-frequency superposed circuit for superimposing a high-frequency wave on laser drive power supply, wiring for transmitting record signals, etc. correspond to the high-frequency noise source 4.

With the configuration as described, the conductor 5a reflects a part or the whole of the vertically-polarized wave component radiated toward the front bezel 6 among electromagnetic waves as the high-frequency noise radiated from the high-frequency noise source 4 on the circuit board 3 during the operation of the electronic device 1. This is due to setting the length of the conductor 5a not less than a quarter or a half of the wavelength of the high-frequency noise, as in the case of a reflector of a multi-element antenna. The electromagnetic wave as the high-frequency noise reflected at the conductor 5a does not travel toward the front bezel 6 but travels in other directions in the enclosure 2. Thus, at least, the high-frequency noise reflected outside the electronic device 1 through the front bezel 6 can be suppressed.

As described above, according to the first embodiment, since a part or the whole of the high-frequency noise radiated from the high-frequency noise source 4 is shielded with the reflection at the conductor 5a in the enclosure 2, the amount of high-frequency noise radiated outside the electronic device 1 through the front bezel 6 can be suppressed. This can greatly reduce also interference in devices placed in proximity to the electronic device 1.

FIG. 2 shows a configuration example of an electronic device according to a second embodiment of the present invention in the case where a horizontally-polarized wave component (polarized wave component in the xy-plane) among high-frequency noise radiated from the inside of the electronic device is shielded within the device.

FIG. 2 illustrates an electronic device 1′ according to the second embodiment of the present invention and a rod-like conductor 5b as a noise reflecting unit. The other parts are the same as in the first embodiment of FIG. 1 and the same notations as in FIG. 1 are assigned. The conductor 5b is placed at an appropriate position between the high-frequency noise source 4 and the front bezel 6 in the enclosure 2 in a state where the conductor 5b has a length not less than a half of the wavelength of the high-frequency noise and both ends thereof are electrically open or in a state where the conductor 5b has a length not less than a quarter of the wavelength of the high-frequency noise and one end makes electrical connection to the enclosure 2 directly or indirectly and the other end is electrically open. The number of conductors 5b is one or more. As in the case of the conductor 5a in the first embodiment, if a frequency of the high-frequency noise is 2×10⁹ Hz for example, the length of the conductor 5b is made not less than approx. 7.5×10⁻² m in the case where both ends of the conductor 5b are electrically open and the length is not less than a half of the wavelength of the high-frequency noise, or the length is made not less than approx. 3.75×10⁻² m in the case where one end of the conductor 5b makes electrical connection to the enclosure 2 directly or indirectly and the length is not less than a quarter of the wavelength of the high-frequency noise.

With the configuration as described, the conductor 5b reflects a part or the whole of the horizontally-polarized wave component radiated toward the front bezel 6 among electromagnetic waves as the high-frequency noise radiated from the high-frequency noise source 4 on the circuit board 3 during the operation of the electronic device 1′. This is due to setting the length of the conductor 5b not less than a quarter or a half of the wavelength of the high-frequency noise based on the same principle as in the reflector of the multi-element antenna, as in the case of the conductor 5a in the first embodiment. The electromagnetic wave as the high-frequency noise reflected at the conductor 5b does not travel toward the front bezel 6 but travels in other directions in the enclosure 2. Thus, at least, the high-frequency noise reflected outside the electronic device 1′ through the front bezel 6 can be suppressed. The second embodiment as well as the first embodiment can be applied to an optical disk apparatus for example.

As described above, according to the second embodiment, since a part or the whole of the high-frequency noise radiated from the high-frequency noise source 4 is shielded with the reflection at the conductor 5b in the enclosure 2, the amount of high-frequency noise radiated outside the electronic device 1′ through the front bezel 6 can be suppressed. Thus, in the case of the second embodiment as well, interference in devices placed in proximity to the electronic device 1′ can be greatly reduced.

In the configuration according to the first embodiment (FIG. 1), only the conductor 5a is provided as a noise reflecting unit in order to reflect the vertically-polarized wave component of the high-frequency noise, and in the configuration according to the second embodiment (FIG. 2), only the conductor 5b is provided as a noise reflecting unit in order to reflect the horizontally-polarized wave component of the high-frequency noise. However, the present invention is not limited to those described above, and for example it is possible to make a configuration for providing both the conductor 5a and the conductor 5b of a noise reflecting unit. Further, the conductor 5a may not be placed vertically in the enclosure 2 of the electronic device 1, but may be placed diagonally. Furthermore, the conductor 5b may not be placed horizontally in the enclosure 2 of the electronic device 1′, but may be placed diagonally. Moreover, each of the conductor 5a and the conductor 5b may be shaped like a plate, a line, etc. other than a rod. Further, each of the conductor 5a and the conductor 5b may be made up of a plurality of conductors. Furthermore, in the above-described embodiments, each of the conductor 5a and the conductor 5b as a noise reflecting unit is placed at a position between the electronic component emitting the high-frequency noise and the front bezel. However, it may be placed at the front bezel. Furthermore, it may be placed at a position other than the above-mentioned positions. In this case, the high-frequency noise in the corresponding direction can be suppressed.

The foregoing invention has been described in terms of preferred embodiments. However, those skilled, in the art will recognize that many variations of such embodiments exist. Such variations are intended to be within the scope of the present invention and the appended claims.

1. An electronic device which contains an electronic component in an enclosure made of conductive material, the electronic device comprising:
a front bezel placed at an opening of the enclosure; and
a reflecting unit for reflecting high-frequency noise in the enclosure, which is placed between the electronic component emitting the high-frequency noise and the front bezel.

2. An electronic device which contains an electronic component in an enclosure made of conductive material, the electronic device comprising:
a front bezel placed at an opening of the enclosure; and
a conductor which is placed between the electronic component emitting high-frequency noise and the front bezel;
wherein the conductor has a length not less than a half of the wavelength of the high-frequency noise and both ends thereof are electrically open in the enclosure such that the conductor prevents the high-frequency noise from radiating outside the electronic device through the font bezel.

3. An electronic device which contains an electronic component in an enclosure made of conductive material, the electronic device comprising:
a front bezel placed at an opening of the enclosure; and
a conductor which is placed between the electronic component emitting high-frequency noise and the front bezel;
wherein the conductor has a length not less than a quarter of the wavelength of the high-frequency noise and one end makes electrical connection to the enclosure directly or indirectly and the other end is electrically open in the enclosure such that the conductor prevents the high-frequency noise from radiating outside the electronic device through the font bezel.

4. The electronic device according to claim 1, claim 2, or claim 3, wherein the electronic device is an optical disk apparatus that contains a laser diode as the electronic component in the enclosure.

5. The electronic device according to claim 2 or claim 3, wherein the conductor is a rod-like conductor.

6. An electronic device which contains an electronic component emitting high-frequency noise, in an enclosure made of conductive material, the electronic device comprising:
a front bezel placed at an opening of the enclosure; and
a reflecting unit for reflecting high-frequency noise, which is placed at the front bezel.

7. The electronic device according to claim 6, wherein the reflecting unit has a length not less than a half of the wavelength of the high-frequency noise and both ends thereof are electrically open.

8. The electronic device according to claim 6, wherein the reflecting unit has a length not less than a quarter of the wavelength of the high-frequency noise and one end makes electrical connection to the enclosure and the other end is electrically open.
